(19) United States
(12) Patent Application Publication
(10) Pub. No.: US 2004/0048504 A1
(43) Pub. Date: Mar. 11, 2004

(54) Electrical connector having a solder-array interface surface

(76) Inventors: John K. Hynes, Prospect, KY (US); Stephen P. Koopman, Floyd Knobs, IN (US)

Correspondence Address: C. John Brannon, Woodard, Emhardt, Naughton, Moriarty and McNett, Bank One Center/Tower, 111 Monument Circle, Suite 3700, Indianapolis, IN, 46204-5137, US

(21) Appl. No.: 09/863,948

(22) Filed: May 23, 2001

(51) Int. Cl. H01R 12/00

(52) U.S. Cl. 439/83

(57) ABSTRACT

An electrical connector adapted to fusingly attach to an electrical device, such as a printed circuit board, including an insulating substrate having a first major face and an oppositely disposed second major face. A plurality of non-recessed apertures extend through the insulating substrate from the first major face to the second major face. A plurality of elongated electrically conducting members or pins extend through the respective apertures into a plurality of reflowable electrical conductors disposed adjacent the first major face. The tails of the pins extend from the second major face. The first major face may be fusingly connected to a second electrical device to put the first electrical device into electrical communication with the second electrical device.

### TECHNICAL FIELD OF THE INVENTION

The present invention relates generally to electrical connectors and, more particularly, to an electrical connector having an interface surface with a plurality of arrayed solder points.

### BACKGROUND OF THE INVENTION

Electrical connectors are used to place electrical devices, such as printed circuit boards, in communication with one another. An electrical connector may be thought of as having two portions, one portion of which connects to a first electrical device and the second portion of which connects to a second electrical device to be put into communication with the first device. To connect the two devices, the two portions of the electrical connector are mated together.

Each portion of the connector includes one set of contacts adapted to communicatively couple to an electronic device and a second set of contacts adapted to matingly couple to the other connector portion. This can be readily accomplished by designating one portion of the connector as having “male” contacts adapted to couple to the other connector portion's “female” contacts. Regardless of the specifics of the contact design, the two connector portions should be adapted to be easily connected and disconnected from each other to respectively electrically link and unlink the electrical devices to which they are connected.

Accordingly, each connector portion is fixedly connected to an electronic device through it's remaining set of contacts. The contacts may be removably or permanently connectable to the electrical device; however, it is usually desired that the connector portion be secured to the electrical device through some physical mechanism. Typically, the connector portions are secured to electrical devices by fusing the contacts to contact pads or the like formed on the electrical device.

Recently, there has been a trend toward the miniaturization of most electrical devices. As electrical devices become smaller and more complex, the electrical connectors used with these devices must also become smaller and be able to accommodate the more complex devices. One problem with miniaturized electrical connectors arises from the increased precision of placement necessary to produce the proper positioning and connection of the connector contacts onto the device. This problem is exacerbated by the ever increasing input/output (I/O) density requirements demanded of the progressively smaller electrical connectors by increasingly miniaturized electrical devices.

One means of addressing the need for increased I/O density is to provide an arrayed connector. Such a connector can provide a high-density two-dimensional array of contact terminals for interfacing with an electrical device. However, arrayed connectors present attachment difficulties regarding connection to devices (i.e., circuit boards or substrates) since most of the contact terminals must necessarily be positioned in the interior of the two-dimensional array area and are accordingly difficult to align upon connection, visually inspect, and/or repair.

One attempt to provide a high-density electrical connector interface has been to use a ball grid array (BGA). The BGA offers the advantages of a precisely formed high-density array of solder contacts available to interconnect with a substrate. However, variation in the dimensions and/or placement of solder balls at the interface can lead to an uneven or non-coplanar interface and intermittent or poor electrical contact. Also, the presence of oversized or extra solder balls present in the connector interface can result in shorted connections and degraded connector performance.

There is therefore a need for an electrical connector design that reliably provides increased I/O density with an even, coplanar interface characterized by an array of precisely positioned solder balls. The present invention is directed towards meeting this need.

### SUMMARY OF THE INVENTION

The present invention relates to an electrical connector adapted to fusingly attach to an electrical device, such as a printed circuit board. The electrical connector includes an insulating substrate having a first major face and an oppositely disposed second major face. A plurality of non-recessed apertures extend through the insulating substrate from the first major face to the second major face. A plurality of elongated electrically conducting members or pins extend through the respective apertures into a plurality of reflowable electrical conductors disposed adjacent the first major face. The tails of the pins extend from the second major face, and can be connected to an electrical device. The first major face may be fusingly connected to a second electrical device having electrical contact pads arrayed to match the positioning of the reflowable electrical conductors disposed on the first major face. The reflowable electrical conductors are heated and reflowed onto the respective electrical contacts and then cooled to fusingly connect the electrical connector to the second electrical device. A first electrical device connected to the electrical connector will thusly be put into electrical communication with the second electrical device.

One object of the present invention is to provide an improved electrical connector device. Related objects and advantages of the present invention will be apparent from the following description.

### BRIEF DESCRIPTION OF THE DRAWINGS

FIG. 1 is a top plan view of a first embodiment electrical connector of the present invention.

FIG. 2 is a partial side perspective view of the embodiment of FIG. 1.

FIG. 3 is a partial side sectional schematic view of the embodiment of FIG. 1.

FIG. 4 is a partial side perspective view of a second embodiment of the present invention.

FIG. 5 is a partial side sectional view of three pins extending through a substrate and to different lengths into three solder balls.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

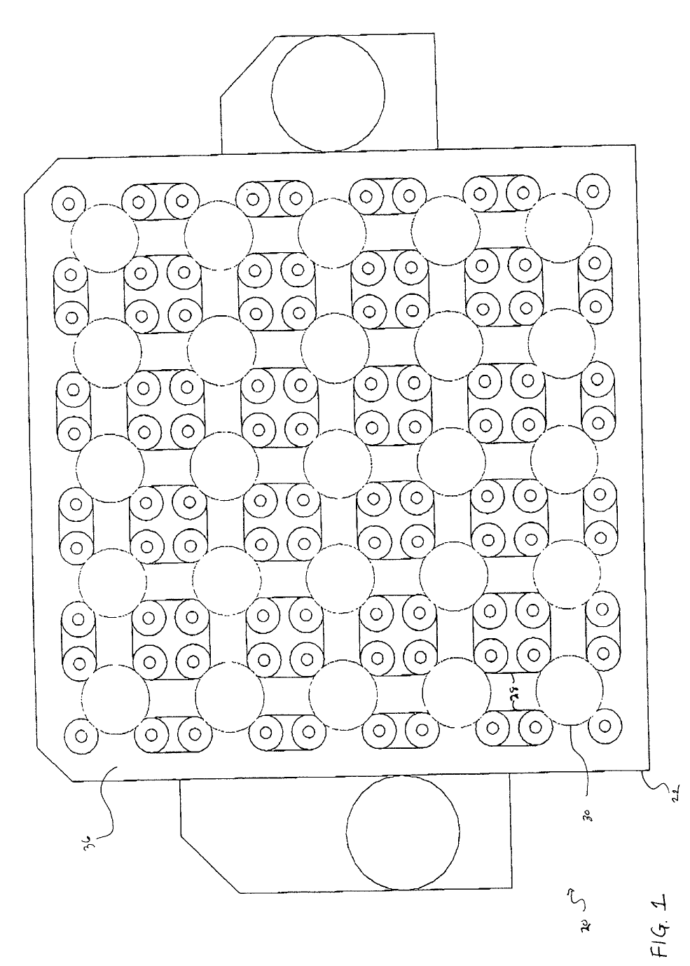

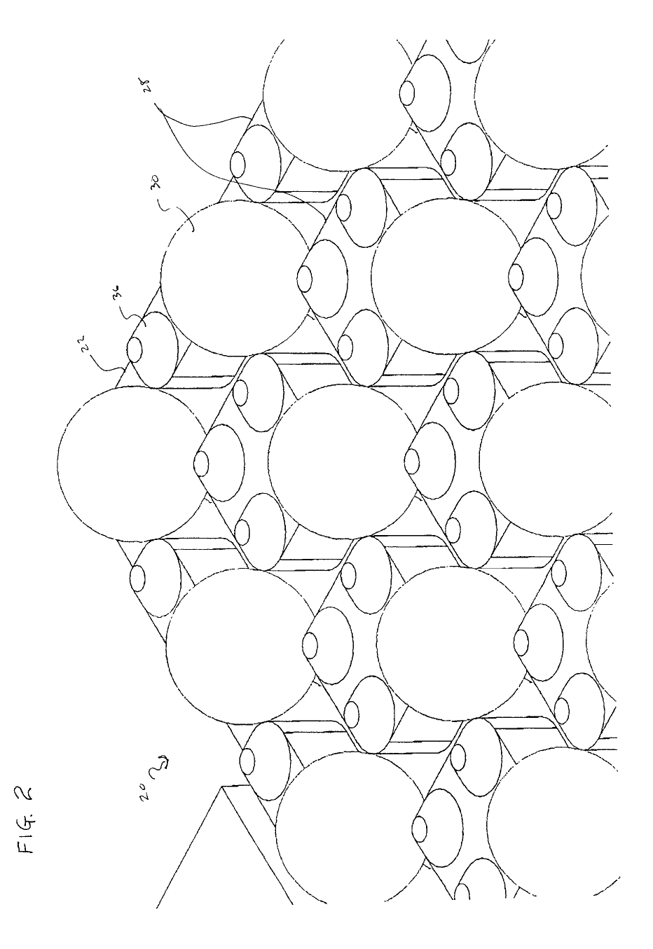

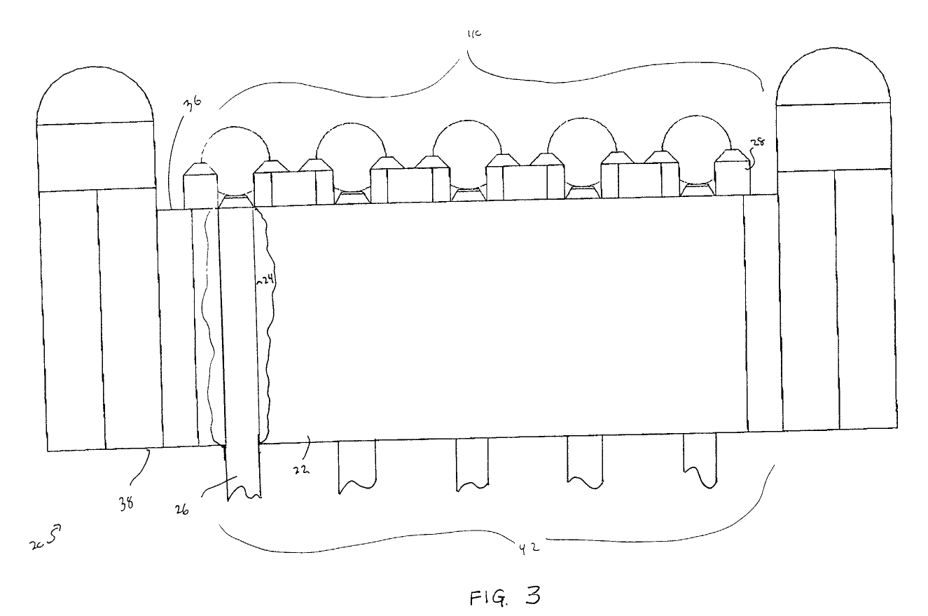

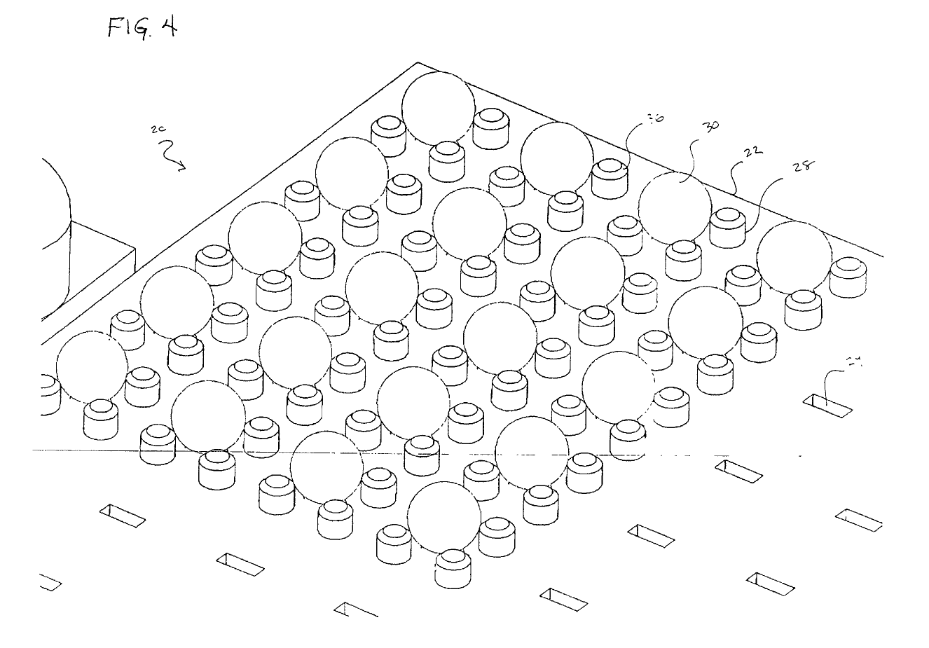

FIGS. 1-3 illustrate a first embodiment of the present invention, an electrical connector 10 including two matable electrical connector portions 20, each having a substantially planar electrically insulating substrate plate 22. A plurality of apertures 24 are formed extending through each substrate plate 22. The apertures 24 are preferably non-recessed (i.e., the apertures do not widen substantially at their ends) and more preferably have walls that extend directly through the substrate plate 22 substantially perpendicularly to the major plane of the plate 22. The apertures 24 may be chamfered at the surface of the plate 22 due to machining requirements. Elongated electrically conducting members or pins 26 extend through the apertures 24. The pins 26 and apertures 24 preferably have the same or similar cross-sectional shapes, such as circular or rectangular (see FIG. 4), to accommodate a tight fit. Preferably, the pins 26 are inserted snugly into the apertures 24. More preferably, each pin 26 enjoys an interference fit in an aperture 24.

Each connector portion 20 also includes a plurality of posts 28 extending from its surface. Each connector portion 20 further includes a plurality of reflowable electrical conductors 30, such as solder balls, positioned over the apertures 24. The posts 28 are preferably positioned to substantially surround each aperture 24, effectively limiting the size of the solder ball 30 positioned thereover. Additionally, the posts 28 are preferably arrayed such that there is room for only one solder ball 30 over each aperture 24 and more preferably, the posts 28 are positioned such that each solder ball 30 may only sit over an aperture 24. In other words, the posts 28 are disposed such that the presence of the posts 28 prevents extra solder balls 30 from sitting on the surface of the connector portion 20 where they might potentially participate in an unplanned electrical connection (i.e., an electrical short circuit) on the connector portion 20.

Each post 28 is preferably regularly shaped and preferably includes a flattened conical surface 32 at its apex, although the posts 28 may have any convenient shape. In the illustrated embodiment, the posts 28 are generally rectangular pillars with a flattened conical surface 32 formed at each corner at the top (for a total of four surfaces 32). Alternately, the posts 28 may have the general shape of right circular cylinders ending in flattened conical surfaces 32 (see the second embodiment of the present invention illustrated in FIG. 4). However, any convenient cross-sectional shape may be chosen that allows the posts 28 to define spaces over each of the apertures 24 large enough for solder ball occupation while reducing the remaining probability of solder ball occupation elsewhere on the surface of the connector portion 20. It is contemplated that by precisely controlling post size, cross-sectional shape, and positioning, the surface of the connector portion 20 may be tailored such that only solder balls 30 of precisely controlled sizes may be placed thereupon without any excess space remaining for unintentional solder ball occupancy.

The reflowable electrical conductors 30 are preferably solder in composition and are preferably spherical in shape. However, the reflowable electrical conductors 30 may be formed of any convenient low melting or low-temperature softening electrically conducting composition that may be resolidified without experiencing a substantial shift in its electrical properties. The reflowable electrical conductor 30 composition may likewise include fusible electrically conducting ceramic compositions or polymers.

The electrically insulating substrate plate 22 preferably includes a first major surface 36 from which the posts 28 extend and upon which the reflowable electrical conductors 30 sit. The plate 22 also preferably includes a second major surface 38, oppositely disposed from the first major surface 36 and from which the tails of the pins 26 extend. The first major surface 36 is adapted to face a first electrical device (not shown) having electrical contact pads oriented such that the array of solder balls 30 may be heated and reflowed to fuse each solder ball 30 to both a pin 26 and a pre-selected electrical pad. In other words, solder balls 30 are impaled upon pins 26 extending from the first major surface 36 to define a fusing interface 40, i.e., an interface that is fusingly connectable to an electrical device. The second major surface 38 is adapted to be removably electrically connected to another connector portion 20 connected, either directly or indirectly, to a second electrical device (not shown). Therefore, the two connector portions 20 matingly join to put the two devices in electrical communication with each other. In other words, the second major surface 38 of one connector portion 20 hosts a non-fusing interface 42, removably connectable to the second major surface 38 of another connector portion 42. The major surfaces 38 of the connector portions may be of any convenient removably couplable design, such as interconnectable male and female contacts or the like.

The connector portion 20 also includes one or more alignment posts 50 extending therefrom. The alignment posts 50 are adapted to extend into alignment receptors (not shown) formed in the surface of the electrical device to which the electrical connector portion 20 is to be joined. The alignment posts 50 serve to guide the solder balls 30 onto the arrayed contact pads (not shown) of the electrical device to ensure proper alignment and good electrical connection of the connector portion 20 to the electrical device.

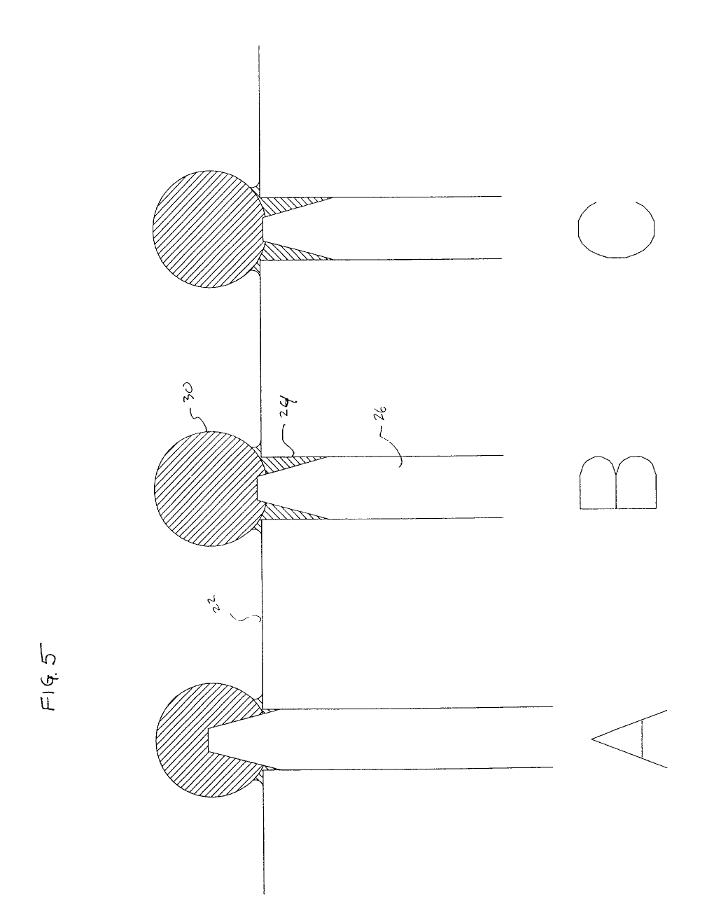

The solder balls 30 are preferably reflowed onto the ends of the pins 26 extending from the first major surface 36 of a respective connector portion 20. This is accomplished by heating the solder balls 30 sufficiently to soften the solder balls 30 and then extending the pins 26 thereinto. The so-impaled solder balls 30 are then cooled and resolidified. The pins 26 may be extended substantially into the solder balls 30 (see FIG. 5, configuration A) or just far enough in to secure the resolidified solder balls 30 onto the pins (see FIG. 5, configurations B and C).

In operation, the first major surface 36 is aligned with a first electrical device (not shown) having electrical contact pads in a predetermined configuration (i.e., wherein each contact pad is positioned to receive a solder ball 30) by sliding the contact posts 50 into the contact post receptors in the surface of the device. The solder balls 30 are heated and reflowed onto the respective contact pads. The reflowed solder balls 30 are then cooled such that they are each fused to both a respective pin 26 and a respective contact pad, thereby forming an electrical connection between the two. The second major surface 38 may then be removably matingly connected to the second major surface 38 of a compatible electrical device, such as another connector portion 20 likewise connected to an electrical device, such that the first and second electrical devices are put into electrical communication by the coupled electrical connector portions 20. The second major surface 38 could also be connected to an intermediate device, such as an electrical cable having a matable interface, or even directly to a second device such a circuit board adapted to matingly connect to the second major surface 38.

Referring to FIG. 4, a second embodiment of the present invention is shown. FIG. 4 illustrates an electrical connector portion 20 similar to the one described above but having smaller posts 28 disposed around the solder balls 30. In this illustrated embodiment, the posts 28 are generally cylindrical with flattened top surfaces 32. The posts 28 of FIG. 4 are also shorter than the solder balls 30. In other words, the diameter of the average solder ball 30 is greater than the height of the average post 28. However, the posts of other embodiments may be taller than the solder balls. The posts 28 of this embodiment are regularly arrayed so as to restrain the solder balls 30 in position over the apertures 24. FIG. 4 further illustrates an alignment post 50 adapted to extend into an alignment post receptor formed in the surface of an electrical device to which the connector portion 20 is to be coupled.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are to be desired to be protected.

What is claimed is:

1. An electrical connector portion, comprising:
an insulating substrate having a first major face and an oppositely disposed second major face;
a plurality of non-recessed apertures extending through the insulating substrate from the first major face to the second major face;
a plurality of elongated electrically conducting members extending through the respective apertures; and
a plurality of reflowable electrical conductors disposed adjacent the first major face;
wherein each elongated electrical conductor extends into a respective reflowable electrical conductor.

2. The electrical connector portion of claim 1 wherein the elongated electrical conductors extend substantially beyond the first major face and the second major face.

3. The electrical connector portion of claim 1 wherein the apertures are substantially right circular cylindrical in shape.

4. The electrical connector portion of claim 1 wherein the apertures are rectangular slots.

5. The electrical connector portion of claim 1 further comprising a plurality of insulating posts extending from the first major face.

6. The electrical connector portion of claim 5 wherein the length each post is greater than the diameter of an adjacent solder ball.

7. The electrical connector portion of claim 5 wherein the length of each post is less than the diameter of an adjacent solder ball.

8. The electrical connector portion of claim 5 wherein the posts are substantially rectangular in cross-section and wherein each post further comprises at least one flattened conical contact surface formed thereon.

9. The electrical connector portion of claim 5 wherein each post further comprises four flattened conical contact surfaces and wherein the flattened conical contact surfaces are arrayed in a rectangular orientation.

10. The electrical connector portion of claim 1 wherein the elongated electrical conductors are adapted to be matingly engaged by the elongated conductors of a second electrical connector portion positioned adjacent the second major face.

11. The connector of claim 1 wherein the reflowable electrical conductors are adapted to fusingly engage an electrical device positioned adjacent the first major face.

12. An electrical connection device, comprising:
an first insulating plate, having a first plate first face for engaging a first device and a first plate second face;
a second insulating plate, having a second plate first face for engaging a second device and a second plate second face for removably engaging a first plate second face;
a plurality of apertures formed through each respective insulating plate;
a plurality of insulating posts formed on each respective first face;
a plurality of fusible electrical conductors positioned on each respective first face; and
a plurality of electrically conducting pins extending from each respective second face through the apertures;
wherein each respective pin extends into a respective fusible electrical conductor.

13. The device of claim 12 wherein the apertures are positioned in an array and wherein posts are arrayed around the apertures.

14. The device of claim 13 wherein the posts are arrayed to form receptacles for holding the fusible electrical conductors substantially over the apertures.

15. The device of claim 12 wherein the posts are substantially rectangular in cross-section and wherein each post further comprises at least one flattened conical contact surface formed thereon.

16. The device of claim 15 wherein each post further comprises four flattened conical contact surfaces and wherein the flattened conical contact surfaces are arrayed in a rectangular orientation.

17. The device of claim 12 further comprising a first device fusingly engaged to the first plate first face and a second device fusingly engaged to the second plate first face, wherein the first plate second face is adapted to removably matingly engage the second plate second face, and wherein the first and second devices are in electrical communication through the matingly engaged first and second insulating plates.

18. An electrical connector apparatus, comprising:
a first electrically insulating connector body having a first substantially planar major side and a second, oppositely disposed substantially planar major side;
a second electrically insulating connector body having a first substantially planar major side and a second, oppositely disposed substantially planar major side;
a fusing interface formed on each respective first major side;
a non-fusing interface formed on each respective second major side;
a plurality of non-recessed apertures formed through the respective electrically insulating connector bodies; and
a plurality of electrically conducting members extending through the respective apertures;
wherein each respective fusing interface is adapted to be fusingly connected to a respective electrical device;
wherein each respective non-fusing interface is adapted to be removably connected to another non-fusing interface; and
wherein a first electrical device fusingly connected to the first electrically insulating connector body is adapted to be put into electrical communication with a second electrical device fusingly connected to second electrically insulating connector body through mating connection of the respective non-fusing interfaces.

19. The device of claim 18 wherein each respective fusing interface further comprises a plurality of solder balls and wherein each electrically conducting member extends through a respective non-recessed aperture into a respective solder ball.

20. The device of claim 18 further comprising a plurality of insulating posts extending from the first major side, wherein the insulating posts extend a post distance away from the first major surface, wherein the fusing interface has a fusing interface thickness, and wherein the post distance is substantially equal to the fusing interface thickness.

21. A method for producing an electrical connector, comprising the steps of:
a) providing an insulated plate having a first planar side and a second, oppositely disposed planar side and having a plurality of non-recessed apertures formed therethrough;
b) extending a plurality of electrically conducting pins through the respective apertures;
c) impaling a solder ball on each respective pin extending from the second planar side such that each pin penetrates the surface of a respective solder ball only once;
d) removably connecting a first electronic device to the pins on the first planar side; and
e) fusingly connecting a second electronic device to the second planar side.

22. The method of claim 21 wherein the second electronic device is an insulated plate having a first planar side and a second, oppositely disposed planar side and having a plurality of non-recessed apertures formed therethrough through which electrically conducting pins extend.
